(19) United States
(12) Patent Application Publication
(10) Pub. No.: US 2022/0287327 A1
(43) Pub. Date: Sep. 15, 2022

(54) MEAT ANALOGUE PRODUCT COMPRISING HYDRATED TEXTURED PLANT PROTEIN

(71) Applicant: SOCIETE DES PRODUITS NESTLE S.A., Vevey (CH)

(72) Inventors: RYAN RIDDLE, Solon, OH (US); SANYASI GADDIPATI, Beachwood, OH (US)

(21) Appl. No.: 17/753,221

(22) PCT Filed: Aug. 13, 2020
(86) PCT No.: PCT/EP2020/072719

§ 371 Date: Feb. 24, 2022

Related U.S. Application Data
(60) Provisional application No. 62/891,485, filed on Aug. 26, 2019.

(51) Int. Cl. A23J 3/22; A23J 3/16; A23J 3/14; A23L 29/262; A23L 11/00

(52) U.S. Cl. CPC A23J 3/227; A23J 3/16; A23J 3/14; A23L 29/262; A23L 11/05; A23L 11/07; A23V 2002/00

(57) ABSTRACT

The present invention relates to a meat analogue product comprising a textured plant protein, a binder, a flavor and optionally a colorant, wherein the textured plant protein is between 65 to 85% hydrated.

The present invention relates to a meat analogue product comprising a textured plant protein, a binder, a flavor and optionally a colorant, wherein the textured plant protein is between 65 to 85% hydrated.

Today's consumer demand more and more meat analogue products as substitutes for real meat based products in their diets. Reasons for this trend are varying from ecological, to economical, ethical and more health conscious considerations.

Typically, such meat analogue products are plant protein extrudates, which are mixed with binders, oil and fat and various colorings and flavorings. However, there are still many limitations as to product quality such in taste, texture and overall visual appearance. Today the trend is towards meat replacement products, which mimic raw meat, meaning that the consumer buys these products ‘raw’ and processes/cooks them in the kitchen in the same way as he would with a corresponding raw meat product. Hence, the consumer expects those meat analogue products also to behave in the same way as raw meat when it comes to the taste, texture, and appearance of those products during the preparation and transformation during a cooking process.

Several solutions exist today and are for example described in WO2015/153666(A1) and WO2017/070303(A1). With today's available meat alternative products, however, many limitations still exist and there is still a clear and persisting need in the art to improve the quality of such meat analogue products, as to taste, texture and particularly also to the visual aspects of such products, as to before, during and after the cooking process.

The object of the present invention is to improve the state of the art and to provide an improved solution as to meat analogue products and their process of manufacture. In particular, the object of the present invention is to provide a raw meat analogue product, where the product requires to be cooked like a real raw meat product before consumption.

The object of the present invention is to provide a meat analogue product, which has an improved quality, when compared to corresponding real meat products, particularly in respect to the textural behaviour, visual aspect and mouthfeel of the product before, during and after the cooking process.

A further object of the present invention is to provide a meat analogue product, which has an improved structural and textural quality in its minced format, which becomes close to that of real raw meat. Particularly, the structural and textural quality of the meat analogue product is improved and mimics real raw meat when it comes to handling the meat analogue product, for example for forming patties or balls directly by a consumer at his home and by hand. These patties or balls can be formed without any egg product, which normally helps to stick together the minced meat analogue product to form a patty or ball. The mouthfeel of the meat analogue product after cooking should mimic real meat.

The object of the present invention is achieved by the subject matter of the independent claims. The dependent claims further develop the idea of the present invention.

Accordingly, the present invention provides a meat analogue product comprising a textured plant protein, a binder, a flavor and optionally a colorant, wherein the textured plant protein is between 65 to 85%, preferably between 70-80%, hydrated.

The inventors surprisingly found, that when the textured plant protein of the meat analogue product is between 65 to 85% hydrated, that a beneficial texture is formed especially in case of a minced meat analogue product. The minced meat analogue product are mainly used to provide two different preparation methods for cooking. First method use the minced meat as Bolognese style product and therefore it should be able to crumble during preparation and the crumbles should have a good texture and bite (mouthfeel). The second method is to use the minced meat to form patties or meat balls and therefore it should stick together. The inventors have found, that if the plant protein composition is hydrated more to than 85%, a slimy and to sticky product is obtained. In case the plant protein composition is hydrated to less than 65%, a too dry product is obtained to form patties or meat balls and the mouthfeel of the product is too dry.

### DETAILED DESCRIPTION OF THE INVENTION

The present invention pertains to a meat analogue product comprising a textured plant protein, a binder, a flavor and optionally a colorant, wherein the textured plant protein is between 65 to 85%, preferably between 70-80%, hydrated.

In an embodiment the present invention relates to a minced meat analogue product comprising a textured plant protein, a binder, a flavor and optionally a colorant, wherein the textured plant protein is between 65 to 85%, preferably between 70-80%, hydrated.

In an embodiment the present invention relates to a meat analogue product comprising between 20 to 35 wt % of textured plant protein (weight percent of the total composition), a binder, a flavor and optionally a colorant, wherein the textured plant protein is between 65 to 85%, preferably between 70-80%, hydrated.

In an embodiment the present invention relates to a minced meat analogue product comprising between 20 to 30 wt % of textured plant protein (weight percent of the total composition), a binder, a flavor and optionally a colorant, wherein the textured plant protein is between 65 to 85%, preferably between 70-80%, hydrated.

The present invention further pertains to a process for the preparation of a meat analogue product comprising a textured plant protein, a binder, a flavor and optionally a colorant, the process comprising the steps of:
a) mixing the textured plant protein with water;
b) adding the binder, the flavor and optionally the colorants, and further mixing to a mass;
c) optionally cooling the mass and adding grinded fat, and further mixing;

wherein the textured plant protein is hydrated between 65 to 85%, preferably between 70-80%, in the meat analogue product.

In an embodiment the present invention further pertains to a process for the preparation of a minced meat analogue product comprising a textured plant protein, a binder, a flavor and optionally a colorant comprising the steps of:
a) mixing the textured plant protein with water;
b) adding the binder, the flavor and optionally the colorants, and further mixing to a mass;
c) optionally cooling the mass and adding grinded fat, and further mixing;
d) grinding the mass from step b) or c) to form strands having a cross-sectional diameter between 2 to 5 mm;

wherein the textured plant protein is hydrated between 65 to 85%, preferably between 70-80%, in the meat analogue product.

Preferably, the meat analogue product of the present invention is raw, meaning that the product was not cooked during its process of manufacture.

“Meat analogue product”, sometimes also called meat alternative, meat substitute, mock meat, faux meat, imitation meat or vegetarian meat, refers herein to a food product, exclusively made from vegetarian ingredients, and which has qualities as to appearance, taste, flavor, and texture as the corresponding real meat product.

“Textured plant protein” is referred in the literature also as ‘texturized plant’ or ‘texturized vegetable protein’ (TVP). It typically refers to a defatted plant protein flour, such as for example defatted soy flour, which is processed e.g. by extrusion into chunks or flakes. In one preferred embodiment of the present invention the meat analogue product comprises between 20 to 35 wt % (weight percent of the total composition) of textured plant protein, preferably between 20 to 30 wt %, preferably between 22 to 30 wt %, preferably between 23 to 28 wt % (weight percent of the total composition).

The term “raw” for the present invention means ‘un-cooked’.

The term “hydrated” means that the textured plant protein is combined with water, which is absorbed by the textured plant protein at a temperature of 22° C. For clarification: A 100% hydrated textured plant protein is a textured plant protein, which is fully saturated with water, i.e. which cannot absorb any further water or any further other aqueous liquid. A 0% hydrated textured plant protein is a textured plant protein, which is absolutely dry and which does not contain any water or moisture. A 50% hydrated textured plant protein is a textured plant protein, which is combined and absorbed with 50% of the amount of water, which it could absorb, or for which it has the capacity to absorb. For the present invention, the capacity of a textured plant protein to absorb water or moisture is considered as being linear in the range from 0% to 100%, and at a temperature of 22° C.

In one preferred embodiment of the present invention, the textured plant protein is between 65 to 85% hydrated, preferably between 67 to 83%, preferably between 70 to 80% hydrated. In an embodiment of the present invention, 15 to 35% of the textured plant protein is not hydrated, preferably 17 to 33%, preferably 20 to 30% is not hydrated. The hydration is determined for the final product.

The term “flavourings” according to this invention means ingredients selected from the group consisting of salt, sugar, vinegar, yeast extract, vegetable powder, bacterial extract, vegetable extract, reaction flavour, hydrolysed plant protein, acid, garnishes, herbs, spices or combinations of these. The meat analogue product according to the invention comprise 0 to 10% flavourings, preferably 0.5 to 10%, preferably 0.5 to 7%, preferably 0.5 to 5%, preferably 1 to 10%, preferably 1 to 5% (by weight of the composition). A bacterial extract is described within WO2009040150 or WO2010105842. A vegetable extract is described within WO2013092296. Vegetable powder means at least one ingredient of onion powder, garlic powder, tomato powder, celery root powder or a combination thereof. Garnishes, herbs, spices or a combination thereof are selected from the group comprising pieces of parsley, celery, fenugreek, lovage, rosemary, marjoram, dill, tarragon, coriander, ginger, lemongrass, curcuma, chili, ginger, paprika, mustard, garlic, onion, turmeric, tomato, coconut milk, cheese, oregano, thyme, basil, chillies, paprika, pimento, jalapeno pepper, white pepper powder and black pepper or combinations of these.

The term “marbled” means that the product has markings and colorings suggestive of marble, and which are marked herein by the intermixture of textured plant protein/binder composition, and a vegetable fat composition. This visual aspect reflects the fat and fat distribution as found in corresponding real meat products.

In one preferred embodiment of the present invention, the meat analogue product does not comprise an ingredient from an animal origin. The product of the present invention is a vegetarian or vegan food product.

In one other embodiment of the present invention, the textured plant protein of the meat analogue product is selected from soy bean protein, pea protein, lentil protein, lupin bean protein, wheat gluten, or a combination thereof. Further appropriate protein sources may be proteins from beans such as green, red or black beans, chickpeas, fava beans, spirulina, or from chia, quinoa or hemp seeds.

In one embodiment of the present invention, the binder of the meat analogue product comprises a cellulose, a fiber, a gelatinized starch, an un-textured protein isolate, or a combination thereof. In one preferred embodiment of the present invention, the binder is methyl-cellulose. In one preferred embodiment of the present invention the meat analogue product comprises between 1 to 3 wt % (weight percent of the total composition) of methyl-cellulose, preferably between 1.25 to 2.5 wt %, more preferably between 1.5 to 2.25 wt % (weight percent of the total composition).

“Gelatinized starch” can be sourced directly as gelatinized starch or can be achieved by cooking native starch with water.

“Un-textured plant protein isolate” refers to a protein isolate, which did not undergo a texturing process such as for example through extrusion.

Preferably, the binder used in the meat analogue product is a paste. A “paste” is a soft plastic composition, made with the cited ingredients and water, and which constitute the binder in the present invention.

In one other embodiment of the present invention, the colorant is selected from bell pepper, beetroot, carrot, black current, malted barley powder or combination thereof. In one embodiment of the present invention the meat analogue product comprises between 0.1 to 5 wt % (weight percent of the total composition) of colorants, preferably between 0.1 to 3 wt % (weight percent of the total composition).

In a preferred embodiment of the present invention, the fat comprised is solid at a temperature of 20° C., preferably at a temperature of 24° C.

In one embodiment of the present invention, the fat is a vegetable fat selected from coconut fat, palm fat, Shea butter, or a combination thereof.

In a preferred embodiment of the present invention, the fat having an average particle size of 0.5-4.5 mm. In a more preferred embodiment of the present invention, the particles have an average particle size of 1-3 mm. The presence of those particles significantly help to improve the forming of the visual aspect of the marbled meat analogue product.

“Average particle size” is defined herein as meaning that 90% of all particles of a batch of particles fall within a particular defined size range in [mm]. The size of the particles were herein determined by sieving through appropriate sieves or a mesh.

In one embodiment of the present invention, the meat analogue product comprises between 1 to 12 wt % fat (weight percent of the total composition), preferably between 1 to 7 wt %, preferably between 1 to 5 wt %, preferably between 2 to 5 wt % (weight percent of the total composition).

In one other embodiment of the present invention, after a heat treatment at 80° C. for at least 5 minutes, the marbled aspect of the meat analogue product is not visible anymore. This should again mimic the process and visual effect when cooking a real fat-marbled meat product.

In an embodiment of the present invention, the meat analogue product further comprises oil. The oil is liquid at a temperature below 20° C.

In one embodiment of the present invention, the oil is a vegetable oil selected from rapeseed oil, sunflower oil, cotton seed oil, peanut oil, soya oil, olive oil, coconut oil, algal oil, safflower oil, corn oil, rice bran oil, sesame oil, hazelnut oil, avocado oil, almond oil, walnut oil or a combination thereof, preferably rapeseed oil.

In one embodiment of the present invention, the meat analogue product comprises between 1 to 12 wt % oil (weight percent of the total composition), preferably between 2 to 7 wt %.

In one important embodiment of the present invention, the meat analogue product is raw and requires cooking before consumption. The meat analogue product of the present invention is intended to mimic raw meat products, which are commercialized as such and are subsequently cooked by the consumer or a professional food out-let. Hence, the meat analogue product of the present invention is raw, meaning that it has not previously been cooked. It is commercialized raw and required to be cooked thereafter by a consumer or a direct food provider.

In one embodiment of the present invention, the meat analogue product is a patty, minced meat, a ball or a sausage, more preferably a minced meat.

Those person skilled in the art will understand that they can freely combine all features of the present invention disclosed herein, described for the different embodiments of the present invention. Further advantages and features of the present invention are apparent from the examples.

### EXAMPLE 1: Hydration Measurement of the Textured Plant Protein

The hydration test measures the amount of ambient water the textured plant protein (TVP) absorbs in 10 minutes. To perform this test, weigh 25 grams of textured plant protein, add to 300 mLs ambient water (access of water), mix the weighed water and TVP, then hydrate for 10 minutes without agitation (other than initial mixing) and drain the water for 10 minutes. Weigh the hydrated product.

Calculate the hydration ratio: (Weight of hydrated product—25)/25. The measurements has shown that at 10 min the total hydration rate of the textured plant protein has been reached.

For textured soy protein a total hydration capacity of TVP of 3.26 has been measured.

For textured pea protein a total hydration capacity of TVP of 3.24 has been measured.

### EXAMPLE 2: Process

Commercially sourced textured plant protein are wetted with water. Oil and colorants are added and mixed for 240 sec at 2000 rpm. All dry ingredients are added and further mixed for 240 sec at 2000 rpm and afterwards cooled down to 15° C. (60° F.) The fat was frozen, cut and grinded, added and mixed to the cooled mass for 120 sec at 500 rpm. The mass is pressed through a meat grinder with a cross-sectional noodle diameter of 3.5 mm to obtain a minced meat product, which is afterwards chilled or frozen.

### EXAMPLE 3 to 9

All examples have been prepared according to example 2.

| | | | | | Comp. | Comp. |
|---|---|---|---|---|---|---|
| Ingredients | Ex. 3 | Ex. 4 | Ex. 5 | Ex. 5 | Ex. 7 | Ex. 8 |
| Textured soy | 25.9 | 23.9 | 25.1 | 27.6 | 22.6 | 29 |
| protein [%] | | | | | | |
| Methyl- | 2 | 2 | 2 | 2 | 2 | 2 |
| cellulose[%] | | | | | | |
| Colorant [%] | 0.5 | 0.5 | 0.5 | 0.5 | 0.5 | 0.5 |
| Flavor [%] | 1.5 | 1.5 | 1.5 | 1.5 | 1.5 | 1.5 |
| Water [%] | 62.1 | 64.1 | 62.9 | 60.4 | 65.4 | 59.0 |
| Coconut oil [%] | 3 | 3 | 3 | 3 | 3 | 3 |
| Rapeseed oil [%] | 5 | 5 | 5 | 5 | 5 | 5 |
| Water/protein | 2.4 | 2.68 | 2.51 | 2.19 | 2.89 | 2.03 |
| ratio | | | | | | |
| % of protein | 73.6 | 82.2 | 77.0 | 67.2 | 88.7 | 62.3 |
| hydration | | | | | | |
| Texture | ++ | + | ++ | + | − | − |
| appearance | | | | | Too wet | Strands |
| | | | | | and slimy | breaks |
| Mouthfeel | ++ | + | ++ | + | − | − |
| | | | | | Too soft | Too dry |

| Ingredients | Ex. 9 |
|---|---|
| Textured pea protein [%] | 25.4 |
| Methyl-cellulose[%] | 2 |
| Colorant [%] | 0.5 |
| Flavor [%] | 1.5 |
| Water [%] | 62.6 |
| Coconut oil [%] | 3 |
| Rapeseed oil [%] | 5 |
| Water/protein ratio | 2.46 |
| % of protein hydration | 75.5 |
| Texture appearance | ++ |
| Mouthfeel | ++ |

7 internal experienced panelists were used to rate the texture and mouthfeel of examples 3 to 9 between “++”, “+”, “neutral (0)”, “−” and “−”. The rating “++” shows the best result and “−” would be the worse result. Only when the textured protein is between 65 to 85% hydrated the texture and mouthfeel of the minced meat product has a good performance rating, showing that the best results are obtained, when the textured protein is between 70 to 80% hydrated.

1. A meat analogue product comprising a textured plant protein, a binder, a flavor, wherein the textured plant protein is between 65 to 85% hydrated.

2. The meat analogue product according to claim 1, which does not comprise an ingredient from an animal origin.

3. The meat analogue product according to claim 1, wherein the textured plant protein is selected from the group consisting of soy bean protein, pea protein, lentil protein, lupin bean protein, wheat gluten, and a combination thereof.

4. The meat analogue product according to claim 1, wherein the textured plant protein is selected in an amount between 20 to 35 wt % (weight percent of the total composition).

5. The meat analogue product according to claim 1, wherein the meat analogue product has a ratio between total water and textured plant protein between 2.25 to 2.75.

6. The meat analogue product according to claim 1, wherein the binder comprises a cellulose, a fiber, a gelatinized starch, an un-textured protein isolate, or a combination thereof.

7. The meat analogue product according to claim 1, wherein the binder is methylcellulose in an amount between 1 to 3 wt % (weight percent of the total composition).

8. The meat analogue product according to claim 1, wherein the meat analogue product further comprises vegetable fat.

9. The meat analogue product according to claim 8, wherein the vegetable fat is selected from the group consisitng of coconut fat, palm fat, shea butter, and a combination thereof.

10. The meat analogue product according to claim 8, wherein the meat analogue product has a visual marbled aspect due to the presence of the fat.

11. The meat analogue product according to claim 8, wherein after a heat treatment at 80° C. for at least 5 minutes, the marbled aspect of the meat analogue product is not visible anymore.

12. The meat analogue product according to claim 1, wherein the meat analogue product is raw and requires cooking before consumption.

13. The meat analogue product according to claim 1, which is a form selected from the group consisting of a patty, a minced meat, a ball and a sausage.

14. A process for the preparation of a meat analogue product comprising a textured plant protein, a binder, and a flavor, the process comprising the steps of:
mixing the textured plant protein with water;
adding the binder and the flavor, and further mixing to a mass;
optionally cooling the mass and adding grinded fat, and further mixing;
wherein the textured plant protein is hydrated between 65 to 85% in the meat analogue product.

15. A process for the preparation of a meat analogue product according to claim 14, wherein the process further comprises pressing the meat analogue product through a meat grinder having a cross-sectional strand diameter between 2 to 5 mm.
